(19) United States
(12) Patent Application Publication
(10) Pub. No.: US 2024/0104590 A1
(43) Pub. Date: Mar. 28, 2024

(54) ITEM INFORMATION PUSH METHOD AND APPARATUS, AND NON-TRANSITORY COMPUTER READABLE STORAGE MEDIUM

(71) Applicants: BEIJING WODONG TIANJUN INFORMATION TECHNOLOGY CO., LTD., BEIJING (CN); BEIJING JINGDONG CENTURY TRADING CO., LTD., BEIJING (CN)

(72) Inventors: Qingqing ZHANG, BEIJING (CN); Shanlin LI, BEIJING (CN); Rui MAO, BEIJING (CN); Yang PAN, BEIJING (CN)

(21) Appl. No.: 18/253,871

(22) PCT Filed: Nov. 2, 2021
(86) PCT No.: PCT/CN2021/128139

§ 371 Date: May 22, 2023

(30) Foreign Application Priority Data
Nov. 23, 2020 (CN) 202011320661.4

(51) Int. Cl. G06Q 30/0202; G06Q 30/0601

(52) U.S. Cl. CPC G06Q 30/0202; G06Q 30/0631

(57) ABSTRACT

The present disclosure relates to an item information push method. The item information push method includes: acquiring a plurality of attribute value sets of a to-be-promoted item according to preset value sets of a plurality of specified attributes; for the each attribute value set, determining an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms; setting attribute values of the plurality of specified attributes of the to-be-promoted item according to the determined estimated warehouse-out quantity corresponding to the each attribute value set and the one set of values in the each attribute value set and sending the set attribute values to the plurality of promotion platforms.

### CROSS-REFERENCE TO RELATED APPLICATIONS

The present disclosure is a U.S. National Stage Application under 35 U.S.C. § 371 of International Patent Application No. PCT/CN2021/128139, filed on Nov. 2, 2021, which is based on and claims priority of Chinese application for invention No. 202011320661.4, filed on Nov. 23, 2020, the disclosure of both of which are hereby incorporated into this disclosure by reference in its entirety.

### TECHNICAL FIELD

This disclosure relates to the field of computer technologies, and in particular, to an item information push method and apparatus and a non-transitory computer readable storage medium.

### BACKGROUND

In an e-commerce CPS (Cost Per Sale) system, accurate setting of an attribute of an item is one of core contents for effective promotion of the item.

In the related art, the attribute of the item is set according to an impression (i.e., exposure) ranking of the item in a search scenario, to improve a promotion effect of the item.

### SUMMARY

According to a first aspect of the present disclosure, there is provided an item information push method, comprising: acquiring a plurality of attribute value sets of a to-be-promoted item according to preset value sets of a plurality of specified attributes, wherein each preset value set of the preset value sets comprises a plurality of values of one specified attribute, each attribute value set of the plurality of attribute value sets comprises one set of values of the plurality of specified attributes, and at least one of the plurality of specified attributes has different values in different attribute value sets in the plurality of attribute value sets; for the each attribute value set, determining an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms; setting attribute values of the plurality of specified attributes of the to-be-promoted item according to the determined estimated warehouse-out quantity corresponding to the each attribute value set and the one set of values in the each attribute value set; and sending the set attribute values of the plurality of specified attributes to the plurality of promotion platforms, to promote the to-be-promoted item by the plurality of promotion platforms.

In some embodiments, the determining an estimated warehouse-out quantity of the to-be-promoted item on a plurality of promotion platforms comprises: for the each attribute value set, determining a promotion traffic value of each promotion platform of the plurality of promotion platforms for the to-be-promoted item according to the historical traffic and the historical warehouse-out quantities corresponding to the plurality of reference items on the each promotion platform, wherein the promotion traffic value characterizes, for the to-be-promoted item, an warehouse-out quantity generated by per unit traffic of the each promotion platform; for the each attribute value set, determining estimated traffic of the to-be-promoted item on the each promotion platform according to the historical traffic corresponding to the to-be-promoted item on the each promotion platform; and for the each attribute value set, determining the estimated warehouse-out quantity of the to-be-promoted item on the plurality of promotion platforms according to the promotion traffic values and the estimated traffic of the to-be-promoted item on the plurality of promotion platforms.

In some embodiments, the determining estimated traffic of the to-be-promoted item on the each promotion platform comprises: determining a plurality of historical search words corresponding to the to-be-promoted item on the each promotion platform; and determining, for the each attribute value set, the estimated traffic of the to-be-promoted item on the each promotion platform according to the historical traffic corresponding to the plurality of historical search words on the each promotion platform.

In some embodiments, the determining, for the each attribute value set, the estimated traffic of the to-be-promoted item on the each promotion platform according to the historical traffic corresponding to the plurality of historical search words on the each promotion platform comprises: for the each attribute value set, determining an estimated impression ranking of the to-be-promoted item on the each promotion platform with each historical search word of the plurality of historical search words as a search condition, according to the values of the plurality of specified attributes in the each attribute value set and a current value of at least one additional attribute, wherein the estimated impression ranking is one of a plurality of historical impression rankings of the to-be-promoted item on the each promotion platform with the each historical search word as the search condition; determining a traffic total probability of the to-be-promoted item on the each promotion platform according to the historical traffic corresponding to the plurality of historical search words, historical traffic corresponding to the plurality of historical impression rankings, and the estimated impression ranking corresponding to the each historical search word on the each promotion platform, wherein the traffic total probability characterizes a traffic ratio of the to-be-promoted item on the each promotion platform; for the each promotion platform, determining a traffic marginal probability of the each promotion platform according to historical total traffic corresponding to the plurality of historical search words on the each promotion platform and historical total traffic corresponding to all of the plurality of historical search words on all of the plurality of promotion platforms; and for the each attribute value set, determining the estimated traffic of the each promotion platform according to the traffic marginal probability and the traffic total probability corresponding to the each promotion platform and the historical total traffic corresponding to the plurality of historical search words.

In some embodiments, the determining a traffic total probability of the to-be-promoted item on the each promotion platform comprises: for the each historical search word, determining a traffic marginal probability of the each historical search word on the each promotion platform according to the historical total traffic corresponding to the each historical search word on the each promotion platform and the historical total traffic corresponding to all of the plurality of historical search words on all of the plurality of promotion platforms; for the each historical search word, determining a traffic conditional probability of each historical impression ranking of the plurality of historical impression rankings of the to-be-promoted item on the each promotion platform with the each historical search word as the condition, according to the historical traffic of the to-be-promoted item corresponding to the each historical impression ranking on the each promotion platform and the historical total traffic of the to-be-promoted item corresponding to the each historical search word on the each promotion platform; for the each historical search word, determining a traffic conditional probability corresponding to the estimated impression ranking from the traffic conditional probabilities of the plurality of historical impression rankings; and for the each promotion platform, determining the traffic total probability of the to-be-promoted item on the each promotion platform according to traffic marginal probabilities of the plurality of historical search words corresponding to the each promotion platform on the each promotion platform and the traffic conditional probability corresponding to the estimated impression ranking.

In some embodiments, the determining a plurality of historical search words corresponding to the to-be-promoted item on the each promotion platform comprises: performing word segmentation on a title of the to-be-promoted item to obtain a plurality of title keywords; and determining, according to the plurality of title keywords, the plurality of historical search words from a plurality of search words corresponding to the to-be-promoted item on the each promotion platform in a first historical time period.

In some embodiments, the determining the plurality of historical search words comprises: determining a search keyword fully matched with any of the plurality of title keywords as a historical search word.

In some embodiments, the for the each attribute value set, determining a promotion traffic value of each promotion platform for the to-be-promoted item according to the historical traffic and the historical warehouse-out quantities corresponding to the plurality of reference items on the each promotion platform warehouse-out comprises: for the each promotion platform, determining a reference traffic value of the each promotion platform for each reference item of the plurality of reference items according to the historical traffic and a historical warehouse-out quantity of the each reference item in a second historical time period, wherein the reference traffic value characterizes, for the each reference item, the warehouse-out quantity generated by per unit traffic of the each promotion platform; and determining the promotion traffic value of the each promotion platform for the to-be-promoted item according to the reference traffic value of the each promotion platform for the each reference item.

In some embodiments, the determining the promotion traffic value of the each promotion platform for the to-be-promoted item according to the reference traffic value of the each promotion platform for the each reference item comprises: performing clustering on the plurality of reference items according to historical attribute values of the plurality of specified attributes and a historical attribute value of at least one additional attribute of the plurality of reference items in the second historical time period, to obtain a plurality of reference categories, wherein each reference category of the plurality of reference categories comprises at least one reference item, each reference category corresponds to one attribute value range of each specified attribute, and at least one same specified attribute of different reference categories has different attribute value ranges; for the each reference category and the each promotion platform, determining an average value of a reference traffic value of the each promotion platform for the at least one reference item as a category traffic value of the each promotion platform for the each reference category; for the each attribute value set, determining a reference category corresponding to the each attribute value set according to the values of the plurality of specified attributes in the each attribute value set and the attribute value ranges of the plurality of specified attributes corresponding to the plurality of reference categories; and determining the category traffic value of the each promotion platform for the reference category corresponding to the each attribute value set as the promotion traffic value of the each promotion platform for the to-be-promoted item.

In some embodiments, for the each reference item and the each promotion platform, the reference traffic value is in negative correlation with the historical traffic in the second historical time period corresponding to the each reference item and the each promotion platform, and the reference traffic value is in positive correlation with the historical warehouse-out quantity in the second historical time period corresponding to the each reference item and the each promotion platform.

In some embodiments, the setting attribute values of the plurality of specified attributes of the to-be-promoted item comprises: for the each attribute value set, calculating a promotion value of the to-be-promoted item according to the determined estimated warehouse-out quantity and the one set of values in the each attribute value set, wherein the promotion value characterizes a value brought by the promotion of the to-be-promoted item; and setting the attribute values of the plurality of specified attributes of the to-be-promoted item by using an attribute value set corresponding to a maximum promotion value.

According to a second aspect of the present disclosure, there is provided an item information push apparatus, comprising: an acquisition module configured to acquire a plurality of attribute value sets of a to-be-promoted item according to preset value sets of a plurality of specified attributes, wherein each preset value set of the preset value sets comprises a plurality of values of one specified attribute, each attribute value set of the plurality of attribute value sets comprises one set of values of the plurality of specified attributes, and at least one same specified attribute of different attribute value sets has different values; a determination module configured to determine, for the each attribute value set, an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms; a setting module configured to set attribute values of the plurality of specified attributes of the to-be-promoted item according to the determined estimated warehouse-out quantity corresponding to the each attribute value set and the one set of values in the each attribute value set; and a sending module configured to send the set attribute values of the plurality of specified attributes to the plurality of promotion platforms, to promote the to-be-promoted item by the plurality of promotion platforms.

According to a third aspect of the present disclosure, there is provided an item information push apparatus, comprising: a memory; and a processor coupled to the memory, the processor being configured to execute, based on instructions stored in the memory, the item information push method according to any of the above embodiments.

According to a fourth aspect of the present disclosure, there is provided a non-transitory computer readable storage medium having stored thereon computer program instructions which, when executed by a processor, implement the item information push method according to any of the above embodiments.

### BRIEF DESCRIPTION OF THE DRAWINGS

The accompanying drawings, which constitute a part of this specification, illustrate embodiments of the present disclosure and together with the description, serve to explain principles of the present disclosure.

The present disclosure can be more clearly understood according to the following detailed description by referring to the accompanying drawings, in which:

FIG. 1 is a flow diagram illustrating an item information push method according to some embodiments of the present disclosure;

FIG. 2 is a flow diagram illustrating determining an estimated warehouse-out quantity of a to-be-promoted item on a plurality of promotion platforms according to some embodiments of the present disclosure;

FIG. 3 is a flow diagram illustrating determining a promotion traffic value of each promotion platform for a to-be-promoted item according to some embodiments of the present disclosure;

FIG. 4 is a flow diagram illustrating determining estimated traffic of a to-be-promoted item on each promotion platform according to some embodiments of the present disclosure;

FIG. 5 is a flow diagram illustrating determining estimated traffic of a to-be-promoted item on each promotion platform according to historical traffic corresponding to a plurality of historical search words on the each promotion platform according to some embodiments of the present disclosure;

FIG. 6 is a block diagram illustrating an item information push apparatus according to some embodiments of the present disclosure;

FIG. 7 is a block diagram illustrating an item information push apparatus according to other embodiments of the present disclosure;

FIG. 8 is a block diagram illustrating a computer system for implementing some embodiments of the present disclosure.

### DETAILED DESCRIPTION

Various exemplary embodiments of the present disclosure will now be described in detail with reference to the accompanying drawings. It should be noted that: relative arrangements of components and steps, numerical expressions and numerical values set forth in these embodiments do not limit the scope of the present disclosure unless specifically stated otherwise.

Meanwhile, it should be understood that a size of each portion shown in the drawings is not drawn to an actual scale for convenience of the description.

The following description of at least one exemplary embodiment is merely illustrative in nature and is in no way intended to limit this disclosure and its application or use.

Techniques, methods, and devices known to one of ordinary skill in the related art may not be discussed in detail, but the techniques, methods, and devices are intended to be part of the specification where appropriate.

In all examples shown and discussed herein, any specific value should be construed to be merely exemplary, and not taken as a limitation. Thus, other examples of an exemplary embodiment can have different values.

It should be noted that: similar reference numbers and letters refer to similar items in the following drawings, and thus, once one certain item is defined in one drawing, it need not be discussed further in subsequent drawings.

In the related art, an attribute of an item is set according to an impression ranking of the item in a search scenario, which does not consider more comprehensive influence factors, so that accuracy of the setting of the attribute of the item is poor. In addition, the impression ranking of the item in the search scenario is not completely in positive correlation with a promotion effect of the item in an actual application scenario, so that by only setting the attribute of the item to improve the impression ranking, the promotion effect of the item is poor.

In view of the above technical problem, the present disclosure provides a solution, which can improve the accuracy of the attribute setting of the item and improve the promotion effect of the item.

FIG. 1 is a flow diagram illustrating an item information push method according to some embodiments of the present disclosure.

As shown in FIG. 1, the item information push method comprises steps S10 to S70. For example, the item information push method is performed by an item information push apparatus.

In the step S10, a plurality of attribute value sets of a to-be-promoted item are acquired according to preset value sets of a plurality of specified attributes. For example, an identification of the to-be-promoted item can be denoted by K.

In some embodiments, the plurality of specified attributes include an item intrinsic value (price), an item promotion reward value (commission), an item value cut value (coupon). For example, each specified attribute corresponds to one preset value set. Each preset value set includes a plurality of values of one specified attribute.

Taking an example that the plurality of specified attributes are an item intrinsic value, an item promotion reward value, and an item value cut value, a preset value set corresponding to the item intrinsic value is {80,90,100}, a preset value set corresponding to the item promotion reward value is {1,2,3}, and a preset value set corresponding to the item value cut value is {3,5,10}. The preset value sets herein all have an unit of Yuan. In some embodiments, the preset value set corresponding to the item promotion reward value can also be {2%, 5%, 10%}, wherein 2% represents that the item promotion reward value is 2% of the item intrinsic value.

Each attribute value set described above comprises one set of values of the plurality of specified attributes. At least one same specified attribute of different attribute value sets has different values, i.e., at least one of the plurality of specified attributes has different values in different attribute value sets in the plurality of attribute value sets.

Taking the example that the plurality of specified attributes are the item intrinsic value, the item promotion reward value, and the item value cut value, 3×3×3=27 attribute value sets can be acquired. Taking an example that a value of the item intrinsic value is 80, a value of the item promotion reward value is 1, and a value of the item cut value is 3, an attribute value set is {80,1,3}. Similarly, other attribute value sets can be derived by those skilled in the art.

In the step S30, for the each attribute value set, an estimated warehouse-out quantity of the to-be-promoted item on a plurality of promotion platforms are determined, according to historical traffic and historical warehouse-out quantities corresponding to a plurality of reference items and historical traffic corresponding to the to-be-promoted item, on the plurality of promotion platforms. The estimated warehouse-out quantity is total warehouse-out quantity of the to-be-promoted item on the plurality of promotion platforms.

In some embodiments, the promotion platform can be an advertisement platform that can carry promotion advertisements, such as platform DY, a platform, a delivery locker, a browser (advertisement pop-up), or some dedicated promotion clients or platforms (e.g., Jingxi Application).

In some embodiments, traffic comprises an amount of user accesses that are generated by users visiting a promoted item through a specific promotion link, in a process of promoting the item. For example, the generation of the traffic exists in a variety of traffic scenarios such as B-end impression and B-end link conversion. The B-end impression is that when a user searches for an item, the item is displayed on a search page so that the item is impressed, and the user clicks to enter a page of the item so that traffic (i.e., the amount of user accesses) corresponding to the item can be generated. The B-end conversion link is traffic (i.e., the amount of user accesses) corresponding to the item, which are generated when a user enters a detail page of the item by means of conversion link. Data related to these traffic can be automatically recorded and stored by promotion platforms, so that they can be directly acquired by the item information push apparatus from the corresponding promotion platform.

In some embodiments, an warehouse-out quantity is an order volume (or a sales volume) generated by users purchasing a promoted item through a specific promotion link in a process of promoting the item.

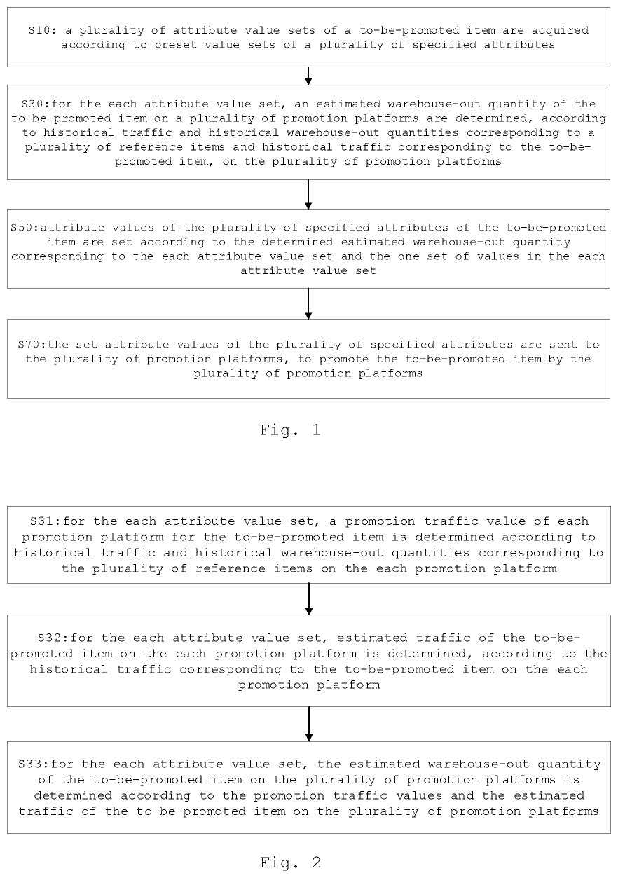

The step S30 shown in FIG. 1 is implemented, for example, in the manner shown in FIG. 2.

FIG. 2 is a flow diagram illustrating determining an estimated warehouse-out quantity of a to-be-promoted item on a plurality of promotion platforms according to some embodiments of the present disclosure.

As shown in FIG. 2, the determining estimated warehouse-out quantity of a to-be-promoted item on a plurality of promotion platforms comprises steps S31 to S33.

In the step S31, for the each attribute value set, a promotion traffic value of each promotion platform for the to-be-promoted item is determined according to historical traffic and historical warehouse-out quantities corresponding to the plurality of reference items on the each promotion platform. The promotion traffic value characterizes, for the to-be-promoted item, an warehouse-out quantity generated by per unit traffic of the each promotion platform. The promotion traffic value can also be referred to as a traffic conversion rate, i.e., a percentage of unit traffic converted to the warehouse-out quantity.

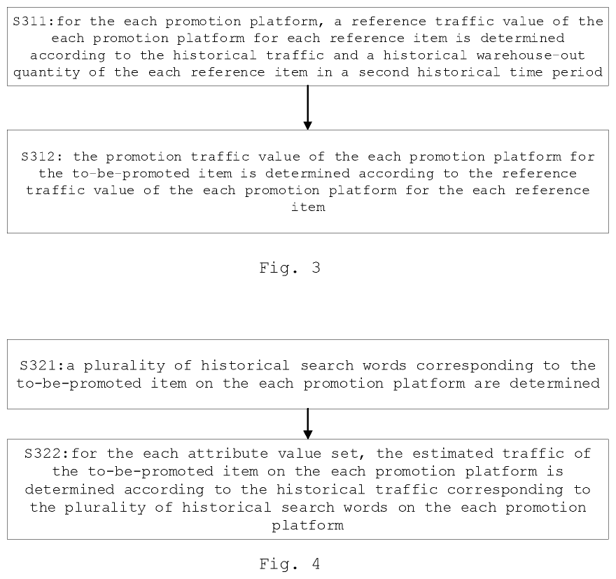

The step S31 is implemented, for example, in the manner shown in FIG. 3 below.

FIG. 3 is a flow diagram illustrating determining a promotion traffic value of each promotion platform for a to-be-promoted item according to some embodiments of the present disclosure.

As shown in FIG. 3, the determining a promotion traffic value of each promotion platform for a to-be-promoted item comprises steps S311 to S312.

In the step S311, for the each promotion platform, a reference traffic value of the each promotion platform for each reference item is determined according to the historical traffic and a historical warehouse-out quantity of the each reference item in a second historical time period. The reference traffic value characterizes, for the each reference item, the warehouse-out quantity generated by per unit traffic of the each promotion platform. For example, the second historical time period is 15 days before a current time moment.

In some embodiments, for the each reference item and the each promotion platform, the reference traffic value is in negative correlation with the historical traffic of the second historical time period corresponding to the each reference item and the each promotion platform, and the reference traffic value is in positive correlation with the historical warehouse-out quantity of the second historical time period corresponding to the each reference item and the each promotion platform.

For example, for a certain reference item, a ratio of historical warehouse-out quantities C to historical traffic E of the reference item in the second historical time period on respective promotion platforms is first calculated, and the ratio is taken as an initial reference traffic value, denoted as x. Then, a mean x̅ and variance S² of initial reference traffic values of the respective promotion platforms are calculated.

According to the mean x̅ and standard deviation σ, parameters a and b for a smoothing operation can be calculated

$$a = \overline{x} ( \frac{\overline{x} ( 1 - \overline{x} )}{{s}^{2}} - 1 ) , b = ( 1 - \overline{x} ) ( \frac{\overline{x} ( 1 - \overline{x} )}{{s}^{2}} - 1 ) .$$

Then, for the reference item and a certain promotion platform, the reference traffic value is

$$X = \frac{C + a}{E + a + b} .$$

In some embodiments, outlier filtering can also be performed on the above reference traffic values X. For example, the mean x̅ and standard deviation a of the reference traffic values of the above reference items on the respective promotion platforms are calculated first, and then the reference traffic value of the each promotion platform is calculated as follows to obtain a normalized reference traffic value

$${X}^{′} = \frac{\vert X - \overline{X} \vert}{σ} .$$

Under the condition that X′ is greater than a specified value (for example, 3), the corresponding reference traffic value X is an outlier, and a value of X is modified into X′. Under the condition that X′ is less than or equal to the specified value, the corresponding reference traffic value X is not an outlier, and it is not modified. By processing the outlier, the accuracy of the attribute setting of the item can be further advanced, and therefore the promotion effect of the item is further improved.

In the step S312, the promotion traffic value of the each promotion platform for the to-be-promoted item is determined according to the reference traffic value of the each promotion platform for the each reference item.

The step S312 is implemented, for example, in the following manner.

Firstly, clustering is performed on the plurality of reference items according to historical attribute values of the plurality of specified attributes and a historical attribute value of at least one additional attribute of the plurality of reference items in the second historical time period, to obtain a plurality of reference categories, wherein each reference category comprises at least one reference item, each reference category corresponds to one attribute value range of each specified attribute, and at least one same specified attribute of different reference categories has different attribute value ranges. For example, clustering is performed using a k-means clustering algorithm.

For example, the plurality of reference categories can be denoted as one reference category set SkuADSet={skuₙ|0<n≤N}, where N is a total number of the reference categories, skuₙ is an nth reference category. It should be understood by those skilled in the art that a center point and radius of the each reference category can be obtained by the clustering, and an attribute value range of each specified attribute of the each reference category can be determined by the center point and the radius. For example, for such an attribute as the intrinsic value of the item, its attribute value range that corresponds to a certain reference category is 10 to 30 Yuan.

Secondly, for the each reference category and the each promotion platform, an average value of a reference traffic value of the each promotion platform for the at least one reference item is determined as a category traffic value of the each promotion platform for the each reference category.

Then, for the each attribute value set, a reference category corresponding to the each attribute value set is determined according to the values of the plurality of specified attributes in the each attribute value set and the attribute value ranges of the plurality of specified attributes corresponding to the plurality of reference categories. In some embodiments, a reference category for which a value of each specified attribute falls within a corresponding attribute value range is determined as the reference category corresponding to the each attribute value set. For example, for the attribute value set {80,1,3}, an attribute value range of the item intrinsic value corresponding to a reference category corresponding to the attribute value set should include 80, an attribute value range of the item promotion reward value should include 1, and an attribute value range of the item value cut value should include 3. One same attribute value set will correspond to only one reference category.

Finally, the category traffic value of the each promotion platform for the reference category corresponding to the each attribute value set is determined as the promotion traffic value of the each promotion platform for the to-be-promoted item.

In the above embodiments, the plurality of reference categories are obtained by the clustering, and the promotion traffic value of the each promotion platform for the to-be-promoted item is determined according to the category traffic value of the reference category. That is, the promotion traffic value is determined according to the reference traffic value of another reference item of the same category as the to-be-promoted item, so that not only an objective traffic conversion rate (traffic value) of the attribute of the to-be-promoted item, but also the traffic values of the respective promotion platforms can be considered, which can improve the accuracy and reliability of determining the promotion traffic value, and thus can further advance the accuracy of the setting of the item attribute, and further improve the promotion effect of the item.

Returning to FIG. 2, in the step S32, for the each attribute value set, estimated traffic of the to-be-promoted item on the each promotion platform is determined, according to the historical traffic corresponding to the to-be-promoted item on the each promotion platform.

The step S32 is implemented, for example, in the manner shown in FIG. 4 below.

FIG. 4 is a flow diagram illustrating determining estimated traffic of a to-be-promoted item on each promotion platform according to some embodiments of the present disclosure.

As shown in FIG. 4, the determining estimated traffic of a to-be-promoted item on each promotion platform comprises steps S321 to S322.

In the step S321, a plurality of historical search words corresponding to the to-be-promoted item on the each promotion platform are determined. For example, historical search words corresponding to the to-be-promoted item are “cellphone”, “HW”, “intelligent cellphone”, and the like, and corresponding promotion platforms are DY, KS, and the like.

In some embodiments, the step S321 is implemented in the following manner.

Firstly, word segmentation on a title of the to-be-promoted item is performed to obtain a plurality of title keywords. For example, word segmentation on a title “HW intelligent cellphone P30” of a to-be-promoted item K=Obj₁ is performed to obtain a plurality of title keywords such as “HW”, “cellphone”, “intelligent”, “intelligent cellphone”, and “cellphone P30”. In some embodiments, word segmentation can be performed by using a jieba word segmentation framework.

Secondly, according to the plurality of title keywords, a plurality of historical search words are determined from a plurality of search keywords corresponding to the to-be-promoted item on the each promotion platform in a first historical time period. For example, the first historical time period is 15 days before a current time moment. The plurality of search keywords are, for example, “HW”, “intelligent cellphone”, “cellphone”, “P30”.

In some embodiments, a search keyword fully matched with any of the plurality of title keywords is determined as a historical search word. For example, by a full-matching operation, it can be determined that search keywords fully matched with the title keyword include “HW”, “cellphone”, “intelligent cellphone”, and thus a plurality of historical search words include “HW”, “cellphone”, “intelligent cellphone”, “P30”.

In the step S322, for the each attribute value set, the estimated traffic of the to-be-promoted item on the each promotion platform is determined according to the historical traffic corresponding to the plurality of historical search words on the each promotion platform.

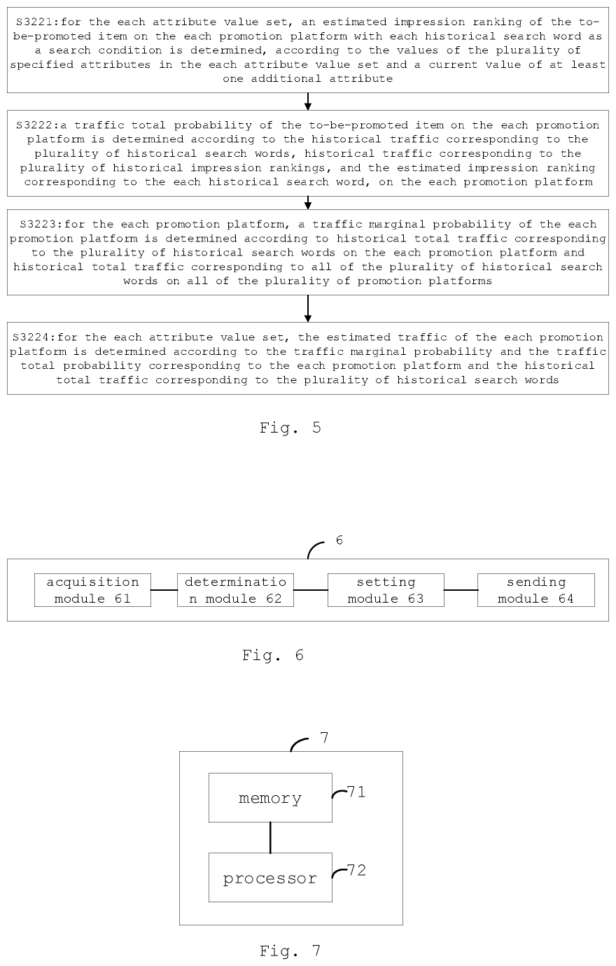

The step S322 shown in FIG. 3 is implemented, for example, in the manner shown in FIG. 5 below.

FIG. 5 is a flow diagram illustrating determining estimated traffic of a to-be-promoted item on each promotion platform according to the historical traffic corresponding to a plurality of historical search words on the each promotion platform according to some embodiments of the present disclosure.

As shown in FIG. 5, the determining estimated traffic of a to-be-promoted item on each promotion platform according to the historical traffic corresponding to a plurality of historical search words on the each promotion platform comprises steps S3221 to S3224.

In the step S3221, for the each attribute value set, an estimated impression ranking of the to-be-promoted item on the each promotion platform with each historical search word as a search condition is determined, according to the values of the plurality of specified attributes in the each attribute value set and a current value of at least one additional attribute. The estimated impression ranking is one of a plurality of historical impression rankings of the to-be-promoted item on the each promotion platform with the each historical search word as the search condition. The historical impression ranking is, in a certain historical time period, a historical search ranking of the to-be-promoted item on the each promotion platform with the each historical search word as the search condition.

In some embodiments, the at least one additional attribute comprises the title of the to-be-promoted item, a store rating of a store to which the to-be-promoted item belongs, information of participating in reporting activities, historical warehouse-out quantity (sales volume), and the like. A current value of the title is, for example, “HW intelligent cellphone P30”, a current value of the store rating of the store to which the to-be-promoted item belongs is, for example, “4.8”, a current value of the information of participating in reporting activities is, for example, a set {reporting}, and a current value of the historical warehouse-out quantity is, for example, 1000000. For example, the current value of the information of participating in reporting activities can also be represented by 0 or 1, where 0 represents not participating in a corresponding activity, 1 represents participating in a corresponding activity, and participation information related to a plurality of activities is represented by one vector.

For example, the values of the respective specified attributes in the each attribute value set and the current value of the additional attribute can be input into some existing search engine ranking algorithm models (such as a BM25 algorithm model), to obtain a corresponding estimated impression ranking. Taking an example that a historical search word is “cellphone” and a promotion platform is DY, it is assumed that the estimated impression ranking corresponding to the attribute value set {80,1,3} is 5. Similarly, the estimated impression ranking corresponding to the historical search word “HW” is 1, and the estimated impression ranking corresponding to the historical search word “intelligent cellphone” is 2.

In the step S3222, a traffic total probability of the to-be-promoted item on the each promotion platform is determined according to the historical traffic corresponding to the plurality of historical search words, historical traffic corresponding to the plurality of historical impression rankings, and the estimated impression ranking corresponding to the each historical search word, on the each promotion platform. The traffic total probability characterizes a traffic ratio of the to-be-promoted item on the each promotion platform. That is, the traffic total probability characterizes a percentage of traffic of the to-be-promoted item on the each promotion platform to the traffic of all items on the each promotion platform.

The above step S3222 is implemented, for example, in the following manner.

Firstly, for the each historical search word, a traffic marginal probability of the each historical search word on the each promotion platform is determined, according to historical total traffic corresponding to the each historical search word on the each promotion platform and the historical total traffic corresponding to all of the plurality of historical search words on all of the plurality of promotion platforms. For example, a ratio of the historical total traffic corresponding to the each historical search word on the each promotion platform to the historical total traffic corresponding to all the historical search words on all the promotion platforms is determined as the traffic marginal probability of the each historical search word on the each promotion platform.

Taking an example that historical search words are “cellphone”, “HW”, “intelligent cellphone” and promotion platforms are DY and KS, if historical total traffic corresponding to the historical search word “cellphone” on the promotion platform “DY” is 100000 user accesses or visits (impressions), historical total traffic corresponding to all the historical search words on the promotion platform “DY” is 1000000 user accesses or visits (“cellphone”, “HW”, and “intelligent cellphone” are only taken as examples here, and all historical search words includes more than the three historical search words), a traffic marginal probability of the historical search word “cellphone” on the promotion platform is P(B=“cellphone”)=10/100=0.1, where B denotes the historical search word. Similarly, it can be found that P(B=“HW”)=0.02, and P(B=“intelligent cellphone”)=0.01.

Secondly, for the each historical search word, a traffic conditional probability of each historical impression ranking of the to-be-promoted item on the each promotion platform with the each historical search word as the condition is determined, according to historical traffic of the to-be-promoted item corresponding to the each historical impression ranking on the each promotion platform and the historical total traffic corresponding to the historical search word on the promotion platform.

For example, a ratio of the historical traffic of the to-be-promoted item corresponding to the each historical impression ranking on the each promotion platform to the historical total traffic of the to-be-promoted item corresponding to the historical search word on the promotion platform is determined as the traffic conditional probability of the each historical impression ranking on the each promotion platform.

Taking an example that historical search words are “cellphone”, “HW”, “intelligent cellphone” and promotion platforms are “DY” and “KS”, if historical impression rankings of the to-be-promoted item on the promotion platform “DY” are 1 to 5, historical traffic corresponding to the historical impression rankings 1 to 5 are respectively 50000, 20000, 10000, 10000, and 10000, and historical total traffic corresponding to the historical search word “cellphone” on the promotion platform “DY” is 100000 user accesses or visits, a traffic conditional probability of the historical impression ranking 1 on the promotion platform “DY” is P(pos=1|B=“cellphone”)=5/10=0.5.

Similarly, it can be derived that a traffic conditional probability of the historical impression ranking 2 on the promotion platform “DY” is P(pos=2|B=“cellphone”)=2/10=0.2, and traffic conditional probabilities of the historical impression rankings 3, 4, 5 on the promotion platform “DY” are P(Pos=3|B=“cellphone”)=1/10=0.1, P(pos=4|B=“cellphone”)=1/10=0.1, and P(pos=5|B=“cellphone”)=1/10=0.1, respectively.

Similar to the above manner of calculating the historical search word “cellphone”, traffic conditional probabilities of historical impression rankings corresponding to other historical search words can also be calculated. Table 1 shows traffic conditional probabilities of historical impression rankings for some or all of the other historical search words.

TABLE 1

| | Historical | | | |
|---|---|---|---|---|
| | total traffic | | Historical | |
| | corresponding to | | traffic | |
| | the historical | | corresponding to | Traffic |
| Historical | search word on | Historical | the historical | condi- |
| search | the promotion | impression | impression | tional |
| word | platform | ranking | ranking | probability |
| HW | 20000 | 1 | 11000 | 0.55 |
| | | 2 | 8000 | 0.4 |
| | | 3 | 1000 | 0.05 |
| intelligent | 10000 | 1 | 7000 | 0.7 |
| cellphone | | 2 | 2100 | 0.21 |
| | | 3 | 900 | 0.09 |

Then, for the each historical search word, a traffic conditional probability corresponding to the estimated impression ranking is determined from the traffic conditional probabilities of the respective historical impression rankings. Taking an example that a historical search word is “cellphone” and a promotion platform is “DY”, it is assumed that an estimated impression ranking corresponding to the attribute value set {80,1,3} is 5. The traffic conditional probability of the historical impression ranking 5 of the historical search word “cellphone” is determined as a traffic conditional probability corresponding to the estimated impression ranking 5, which is P(pos=51B=“cellphone”)=0.1. Similarly, a traffic conditional probability corresponding to the estimated impression ranking 1 of the historical search word “HW” is P(pos=1|B=“HW”)=0.55, and a traffic conditional probability corresponding to the estimated impression ranking 2 of the historical search word “intelligent cellphone” is P(pos=2|B=“intelligent cellphone”)=0.21.

Finally, for the each promotion platform, the traffic tot al probability of the to-be-promoted item on the each promotion pl atform is determined, according to traffic marginal probabilities of the plurality of historical search words corresponding to the e ach promotion platform on the each promotion platform and the traf fic conditional probability corresponding to the estimated impress ion ranking. Taking an example that historical search words are “c ellphone”, “HW” and “intelligent cellphone” and a promotion platfo rm is “DY”, a traffic total probability of the to-be-promoted item K=Obj₁ with the title of “HW intelligent cellphone P30” on the pro motion platform “DY” is P(pos)=P(B=“cellphone”) XP (pos=5|B=“cellph one”)+P (B=“HW”) XP (pos=1|B=“HW”)+P (B=“intelligent cellphone”)×P(p os=2|B=“intelligent cellphone”). The traffic total probability P (pos) is a marginal probability P(K=Obj₁) of a hit impression rank ing of the to-be-promoted item Obj₁.

In the step S3223, for the each promotion platform, a traffic marginal probability of the each promotion platform is determined according to historical total traffic corresponding to the plurality of historical search words on the each promotion platform and historical total traffic corresponding to all of the plurality of historical search words on all of the plurality of promotion platforms. In some embodiments, for the each promotion platform, a ratio of the historical total traffic corresponding to the plurality of historical search words on the each promotion platform to the historical total traffic corresponding to all the historical search words on all the promotion platforms is determined as the traffic marginal probability of the each promotion platform.

For example, if historical total traffic corresponding to all the historical search words on the promotion platform “DY” is 1000000 user visits, and historical total traffic corresponding to all the historical search words (all the historical search words on the respective promotion platforms) on all the promotion platforms is 1 hundred million user visits, a traffic marginal probability of the promotion platform “DY” is P(A=“DY”)=100/10000=0.01. Similarly, a traffic marginal probability of the promotion platform “KS” is P(A=“KS”)=200/10000=0.02.

In the step S3224, for the each attribute value set, the estimated traffic of the each promotion platform is determined according to the traffic marginal probability and the traffic total probability corresponding to the each promotion platform and the historical total traffic corresponding to the plurality of historical search words.

In some embodiments, for the each attribute value set, a product of the traffic marginal probability and the traffic total probability corresponding to the each promotion platform and the historical total traffic corresponding to the plurality of historical search words is determined as the estimated traffic of the each promotion platform.

For example, for the attribute value set {80,1,3}, estimated traffic of the promotion platform “DY” is S(“DY”)=P(K=Obj₁, A=“DY”)×1000000=P (A=“DY”|K=Obj₁)×F(K=Obj₁)×1000000≈P(A=“DY”)×P (K=Obj₁)×1000000=0.01×0.0197×1000000=1970. That is, the estimated traffic of the to-be-promoted item Obj₁ on the promotion platform “DY” is 1970.

Since distribution trends for the respective promotion platforms in terms of the search words are consistent and have extremely high repeatability and coverage, it can be considered that distribution of a traffic conditional probability P(A|K) of the to-be-promoted item K on a promotion platform A and distribution of a traffic marginal probability P(A) on the promotion platform A are basically consistent, and it can also be considered that a joint probability P(KA) of the promotion platform A and the to-be-promoted item K can be calculated approximately by P(KA)=P(K)×P(A).

For example, common promotion platforms include DY and KS, traffic marginal probabilities of DY and KS are respectively 0.1 and 0.2 (among 1000000 impressions, DY and KS have 100000 impressions and 200000 impressions, respectively), and since search words used by DY and KS have high coverage and distribution trends are generally consistent, one tenth and two tenth of impression (traffic) data of the to-be-promoted item K “HW intelligent cellphone P30” are the impressions (traffic) of DY and KS, respectively. Therefore, P(A|K)≈P(A).

Returning to FIG. 2, in the step S33, for the each attribute value set, the estimated warehouse-out quantity of the to-be-promoted item on the plurality of promotion platforms is determined according to the promotion traffic values and the estimated traffic of the to-be-promoted item on the plurality of promotion platforms.

In some embodiments, for the each attribute value set, a product of the promotion traffic values and the estimated traffic of the to-be-promoted item on the plurality of promotion platforms is determined as the estimated warehouse-out quantity (total sales volume or total order volume) of the to-be-promoted item on the plurality of promotion platforms.

For example, by the above steps, promotion traffic values, estimated traffic and estimated warehouse-out quantity of the two promotion platforms of DY and KS are obtained as shown in Table 2.

TABLE 2

| Promotion | Promotion | Estimated | Estimated warehouse- |
|---|---|---|---|
| platform | traffic value | traffic | out quantity |
| DY | 1970 | 0.015 | 32.1645 |
| KS | 1245 | 0.0021 | |

It can be seen from Table 2 that, for a certain attribute value set, estimated warehouse-out quantity are about 32.

Returning to FIG. 1, in the step S50, attribute values of the plurality of specified attributes of the to-be-promoted item are set according to the determined estimated warehouse-out quantity corresponding to the each attribute value set and the one set of values in the each attribute value set.

In the step S70, the set attribute values of the plurality of specified attributes are sent to the plurality of promotion platforms, to promote the to-be-promoted item by the plurality of promotion platforms.

In some embodiments, for the each attribute value set, a promotion value of the to-be-promoted item is calculated according to the determined estimated warehouse-out quantity and the one set of values in the each attribute value set. The promotion value characterizes a value (profit) brought by the promotion of the to-be-promoted item, and the attribute values of the plurality of specified attributes of the to-be-promoted item are set by using an attribute value set corresponding to a maximum promotion value. A formula for calculating the profit is related art, and thus is not be repeated here.

In the above embodiments, according to the historical traffic and the historical warehouse-out quantities of the to-be-promoted item and the plurality of reference items on the plurality of promotion platforms, in combination with the values of the plurality of specified attributes of the to-be-promoted item, the estimated warehouse-out quantity (total sales volume) of the to-be-promoted item on the plurality of promotion platforms are determined, which considers the promotion effect of the traffic of the promotion platform, can advance the accuracy of the attribute setting of the item, and improve the promotion effect of the item.

FIG. 6 is a block diagram illustrating an item information push apparatus according to some embodiments of the present disclosure.

As shown in FIG. 6, the item information push apparatus 6 comprises an acquisition module 61, a determination module 62, a setting module 63, and a sending module 64.

The acquisition module 61 is configured to acquire a plurality of attribute value sets of a to-be-promoted item according to preset value sets of a plurality of specified attributes, wherein each preset value set comprises a plurality of values of one specified attribute, each attribute value set comprises one set of values of the plurality of specified attributes, and at least one same specified attribute of different attribute value sets has different values, as shown in for example the step S10 in FIG. 1.

The determination module 62 is configured to determine, for the each attribute value set, an estimated warehouse-out quantity of the to-be-promoted item on a plurality of promotion platforms, according to historical traffic and historical warehouse-out quantities corresponding to a plurality of reference items and historical traffic corresponding to the to-be-promoted item, on the plurality of promotion platforms, as shown in for example the step S30 in FIG. 1.

The setting module 63 is configured to set attribute values of the plurality of specified attributes of the to-be-promoted item according to the determined estimated warehouse-out quantity corresponding to the each attribute value set and the one set of values in the each attribute value set, as shown in for example the step S50 in FIG. 1.

The sending module 64 is configured to send the set attribute values of the plurality of specified attributes to the plurality of promotion platforms, to promote the to-be-promoted item by the plurality of promotion platforms, as shown in for example the step S70 in FIG. 1.

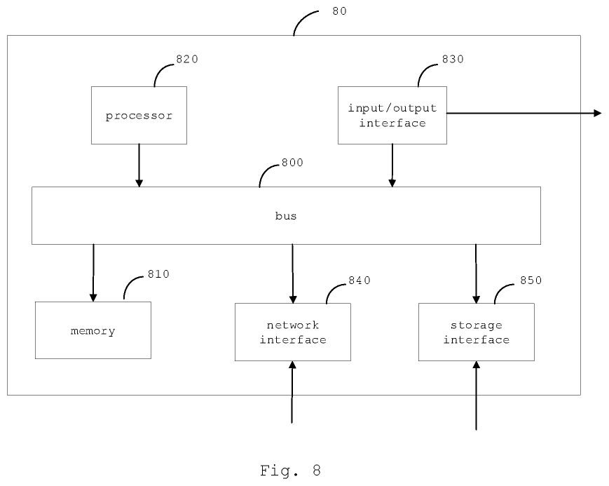

FIG. 7 is a block diagram illustrating an item information push apparatus according to other embodiments of the present disclosure.

As shown in FIG. 7, the item information push apparatus 7 comprises a memory 71; and a processor 72 coupled to the memory 71. The memory 71 is used for storing instructions for executing the corresponding embodiments of the item information push method. The processor 72 is configured to execute, based on the instructions stored in the memory 71, the item information push method in any of the embodiments of the present disclosure.

FIG. 8 is a block diagram illustrating a computer system for implementing some embodiments of the present disclosure.

As shown in FIG. 8, a computer system 80 can be represented in a form of a general-purpose computing device. The computer system 80 comprises a memory 810, a processor 820, and a bus 800 for connecting different system components.

The memory 810 can include, for example, a system memory, non-volatile storage medium, and the like. The system memory has thereon stored, for example, an operating system, an application program, a boot loader, and other programs. The system memory can include a volatile storage medium, such as random access memory (RAM) and/or cache memory. The non-volatile storage medium has thereon stored, for example, instructions to perform the corresponding embodiment of at least one of the item information push methods. The non-volatile storage medium includes, but is not limited to, a magnetic disk memory, optical memory, flash memory, and the like.

The processor 820 can be implemented by discrete hardware components, such as a general-purpose processor, a digital signal processor (DSP), an application specific integrated circuit (ASIC), a field programmable gate array (FPGA) or other programmable logic devices, a discrete gate or transistor, and the like. Accordingly, each module such as the judgment module and the determination module can be implemented by a central processing unit (CPU) running instructions in the memory that perform the corresponding steps, or can be implemented by a dedicated circuit performing the corresponding steps.

The bus 800 can be in any of a variety of bus architectures. For example, the bus architecture includes, but is not limited to, an industry standard architecture (ISA) bus, a micro channel architecture (MCA) bus, and a peripheral component interconnect (PCI) bus.

The computer system 80 can also comprise an input/output interface 830, a network interface 840, a storage interface 850, and the like. These interfaces 830, 840, 850, as well as the memory 810, can be connected with the processor 820 through the bus 800. The input/output interface 830 can provide a connection interface for input/output devices such as a display, a mouse, and a keyboard. The network interface 840 provides a connection interface for a variety of networking devices. The storage interface 850 provides a connection interface for external storage devices such as a floppy disk, a USB flash disk, and an SD card.

Various aspects of the present disclosure are described herein with reference to the flow diagrams and/or block diagrams of the method, apparatus and computer program product according to the embodiments of the present disclosure. It should be understood that each block of the flow diagrams and/or block diagrams, and a combination of the blocks, can be implemented by computer-readable program instructions.

These computer-readable program instructions can be provided to a processor of a general-purpose computer, special-purpose computer, or other programmable apparatuses to produce one machine, such that the instructions, which are executed by the processor, generate means for implementing functions specified in one or more blocks of the flow diagrams and/or block diagrams.

These computer-readable program instructions can also be stored in a computer-readable memory, and these instructions cause a computer to work in a specific manner, thereby producing one article of manufacture, which includes instructions for implementing functions specified in one or more blocks of the flow diagrams and/or block diagrams.

The present disclosure can take a form of an entire hardware embodiment, an entire software embodiment, or an embodiment combining software and hardware aspects.

By means of the item information push method and apparatus and the non-transitory computer readable storage medium in the above embodiments, the accuracy of the attribute setting of the item can be advanced, and the promotion effect of the item can be improved.

So far, the item information push method and apparatus and the non-transitory computer readable storage medium according to the present disclosure have been described in detail. Some details well known in the art have not been described in order to avoid obscuring the concepts of the present disclosure. According to the foregoing description, those skilled in the art can fully appreciate how to implement the technical solution disclosed herein.

1. An item information push method, comprising:
acquiring a plurality of attribute value sets of a to-be-promoted item according to preset value sets of a plurality of specified attributes, wherein each preset value set of the preset value sets comprises a plurality of values of one specified attribute, each attribute value set of the plurality of attribute value sets comprises one set of values of the plurality of specified attributes, and at least one of the plurality of specified attributes has different values in different attribute value sets in the plurality of attribute value sets;
for the each attribute value set, determining an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms;
setting attribute values of the plurality of specified attributes of the to-be-promoted item according to the determined estimated warehouse-out quantity corresponding to the each attribute value set and the one set of values in the each attribute value set; and
sending the set attribute values of the plurality of specified attributes to the plurality of promotion platforms, to promote the to-be-promoted item by the plurality of promotion platforms.

2. The item information push method according to claim 1, wherein the determining an estimated warehouse-out quantity of the to-be-promoted item on a plurality of promotion platforms comprises:
for the each attribute value set, determining a promotion traffic value of each promotion platform of the plurality of promotion platforms for the to-be-promoted item according to the historical traffic and the historical warehouse-out quantities corresponding to the plurality of reference items on the each promotion platform, wherein the promotion traffic value characterizes, for the to-be-promoted item, an warehouse-out quantity generated by per unit traffic of the each promotion platform;
for the each attribute value set, determining estimated traffic of the to-be-promoted item on the each promotion platform according to the historical traffic corresponding to the to-be-promoted item on the each promotion platform; and
for the each attribute value set, determining the estimated warehouse-out quantity of the to-be-promoted item on the plurality of promotion platforms according to the promotion traffic values and the estimated traffic of the to-be-promoted item on the plurality of promotion platforms.

3. The item information push method according to claim 2, wherein the determining estimated traffic of the to-be-promoted item on the each promotion platform comprises:
determining a plurality of historical search words corresponding to the to-be-promoted item on the each promotion platform; and
determining, for the each attribute value set, the estimated traffic of the to-be-promoted item on the each promotion platform according to the historical traffic corresponding to the plurality of historical search words on the each promotion platform.

4. The item information push method according to claim 3, wherein the determining, for the each attribute value set, the estimated traffic of the to-be-promoted item on the each promotion platform according to the historical traffic corresponding to the plurality of historical search words on the each promotion platform comprises:
for the each attribute value set, determining an estimated impression ranking of the to-be-promoted item on the each promotion platform with each historical search word of the plurality of historical search words as a search condition, according to the values of the plurality of specified attributes in the each attribute value set and a current value of at least one additional attribute, wherein the estimated impression ranking is one of a plurality of historical impression rankings of the to-be-promoted item on the each promotion platform with the each historical search word as the search condition;
determining a traffic total probability of the to-be-promoted item on the each promotion platform according to the historical traffic corresponding to the plurality of historical search words, historical traffic corresponding to the plurality of historical impression rankings, and the estimated impression ranking corresponding to the each historical search word on the each promotion platform, wherein the traffic total probability characterizes a traffic ratio of the to-be-promoted item on the each promotion platform;
for the each promotion platform, determining a traffic marginal probability of the each promotion platform according to historical total traffic corresponding to the plurality of historical search words on the each promotion platform and historical total traffic corresponding to all of the plurality of historical search words on all of the plurality of promotion platforms; and
for the each attribute value set, determining the estimated traffic of the each promotion platform according to the traffic marginal probability and the traffic total probability corresponding to the each promotion platform and the historical total traffic corresponding to the plurality of historical search words.

5. The item information push method according to claim 4, wherein the determining a traffic total probability of the to-be-promoted item on the each promotion platform comprises:
for the each historical search word, determining a traffic marginal probability of the each historical search word on the each promotion platform according to the historical total traffic corresponding to the each historical search word on the each promotion platform and the historical total traffic corresponding to all of the plurality of historical search words on all of the plurality of promotion platforms;
for the each historical search word, determining a traffic conditional probability of each historical impression ranking of the plurality of historical impression rankings of the to-be-promoted item on the each promotion platform with the each historical search word as the condition, according to the historical traffic of the to-be-promoted item corresponding to the each historical impression ranking on the each promotion platform and the historical total traffic of the to-be-promoted item corresponding to the each historical search word on the each promotion platform;
for the each historical search word, determining a traffic conditional probability corresponding to the estimated impression ranking from the traffic conditional probabilities of the plurality of historical impression rankings; and
for the each promotion platform, determining the traffic total probability of the to-be-promoted item on the each promotion platform according to traffic marginal probabilities of the plurality of historical search words corresponding to the each promotion platform on the each promotion platform and the traffic conditional probability corresponding to the estimated impression ranking.

6. The item information push method according to claim 3, wherein the determining a plurality of historical search words corresponding to the to-be-promoted item on the each promotion platform comprises:
performing word segmentation on a title of the to-be-promoted item to obtain a plurality of title keywords; and
determining, according to the plurality of title keywords, the plurality of historical search words from a plurality of search words corresponding to the to-be-promoted item on the each promotion platform in a first historical time period.

7. The item information push method according to claim 6, wherein the determining the plurality of historical search words comprises:
determining a search keyword fully matched with any of the plurality of title keywords as a historical search word.

8. The item information push method according to claim 2, wherein the for the each attribute value set, determining a promotion traffic value of each promotion platform for the to-be-promoted item according to the historical traffic and the historical warehouse-out quantities corresponding to the plurality of reference items on the each promotion platform warehouse-out comprises:
for the each promotion platform, determining a reference traffic value of the each promotion platform for each reference item of the plurality of reference items according to the historical traffic and a historical warehouse-out quantity of the each reference item in a second historical time period, wherein the reference traffic value characterizes, for the each reference item, the warehouse-out quantity generated by per unit traffic of the each promotion platform; and
determining the promotion traffic value of the each promotion platform for the to-be-promoted item according to the reference traffic value of the each promotion platform for the each reference item.

9. The item information push method according to claim 8, wherein the determining the promotion traffic value of the each promotion platform for the to-be-promoted item according to the reference traffic value of the each promotion platform for the each reference item comprises:
performing clustering on the plurality of reference items according to historical attribute values of the plurality of specified attributes and a historical attribute value of at least one additional attribute of the plurality of reference items in the second historical time period, to obtain a plurality of reference categories, wherein each reference category of the plurality of reference categories comprises at least one reference item, each reference category corresponds to one attribute value range of each specified attribute, and at least one same specified attribute of different reference categories has different attribute value ranges;
for the each reference category and the each promotion platform, determining an average value of a reference traffic value of the each promotion platform for the at least one reference item as a category traffic value of the each promotion platform for the each reference category;
for the each attribute value set, determining a reference category corresponding to the each attribute value set according to the values of the plurality of specified attributes in the each attribute value set and the attribute value ranges of the plurality of specified attributes corresponding to the plurality of reference categories; and
determining the category traffic value of the each promotion platform for the reference category corresponding to the each attribute value set as the promotion traffic value of the each promotion platform for the to-be-promoted item.

10. The item information push method according to claim 8, wherein for the each reference item and the each promotion platform, the reference traffic value is in negative correlation with the historical traffic in the second historical time period corresponding to the each reference item and the each promotion platform, and the reference traffic value is in positive correlation with the historical warehouse-out quantity in the second historical time period corresponding to the each reference item and the each promotion platform.

11. The item information push method according to claim 1, wherein the setting attribute values of the plurality of specified attributes of the to-be-promoted item comprises:
for the each attribute value set, calculating a promotion value of the to-be-promoted item according to the determined estimated warehouse-out quantity and the one set of values in the each attribute value set, wherein the promotion value characterizes a value brought by the promotion of the to-be-promoted item; and
setting the attribute values of the plurality of specified attributes of the to-be-promoted item by using an attribute value set corresponding to a maximum promotion value.

12. (canceled)

13. An item information push apparatus, comprising:
a memory; and
a processor coupled to the memory, the processor being configured to execute, based on instructions stored in the memory, the item information push method, wherein the item information push method comprises:
acquiring a plurality of attribute value sets of a to-be-promoted item according to preset value sets of a plurality of specified attributes, wherein each preset value set of the preset value sets comprises a plurality of values of one specified attribute, each attribute value set of the plurality of attribute value sets comprises one set of values of the plurality of specified attributes, and at least one of the plurality of specified attributes has different values in different attribute value sets in the plurality of attribute value sets;
for the each attribute value set, determining an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms;
setting attribute values of the plurality of specified attributes of the to-be-promoted item according to the determined estimated warehouse-out quantity corresponding to the each attribute value set and the one set of values in the each attribute value set; and
sending the set attribute values of the plurality of specified attributes to the plurality of promotion platforms, to promote the to-be-promoted item by the plurality of promotion platforms.

14. A non-transitory computer readable storage medium having stored thereon computer program instructions which, when executed by a processor, implement the item information push method, wherein the item information push method comprises:
acquiring a plurality of attribute value sets of a to-be-promoted item according to preset value sets of a plurality of specified attributes, wherein each preset value set of the preset value sets comprises a plurality of values of one specified attribute, each attribute value set of the plurality of attribute value sets comprises one set of values of the plurality of specified attributes, and at least one of the plurality of specified attributes has different values in different attribute value sets in the plurality of attribute value sets;
for the each attribute value set, determining an estimated warehouse-out quantity of the to-be-promoted item on a plurality of promotion platforms, according to historical traffic and historical warehouse-out quantities corresponding to a plurality of reference items and the historical traffic corresponding to the to-be-promoted item, on the plurality of promotion platforms;
setting attribute values of the plurality of specified attributes of the to-be-promoted item according to the determined estimated warehouse-out quantity corresponding to the each attribute value set and the one set of values in the each attribute value set; and
sending the set attribute values of the plurality of specified attributes to the plurality of promotion platforms, to promote the to-be-promoted item by the plurality of promotion platforms.

15. The item information push apparatus according to claim 13, wherein the determining an estimated warehouse-out quantity of the to-be-promoted item on a plurality of promotion platforms comprises:
for the each attribute value set, determining a promotion traffic value of each promotion platform of the plurality of promotion platforms for the to-be-promoted item according to the historical traffic and the historical warehouse-out quantities corresponding to the plurality of reference items on the each promotion platform, wherein the promotion traffic value characterizes, for the to-be-promoted item, an warehouse-out quantity generated by per unit traffic of the each promotion platform;
for the each attribute value set, determining estimated traffic of the to-be-promoted item on the each promotion platform according to the historical traffic corresponding to the to-be-promoted item on the each promotion platform; and
for the each attribute value set, determining the estimated warehouse-out quantity of the to-be-promoted item on the plurality of promotion platforms according to the promotion traffic values and the estimated traffic of the to-be-promoted item on the plurality of promotion platforms.

16. The item information push apparatus according to claim 15, wherein the determining estimated traffic of the to-be-promoted item on the each promotion platform comprises:
determining a plurality of historical search words corresponding to the to-be-promoted item on the each promotion platform; and
determining, for the each attribute value set, the estimated traffic of the to-be-promoted item on the each promotion platform according to the historical traffic corresponding to the plurality of historical search words on the each promotion platform.

17. The item information push apparatus according to claim 16, wherein the determining, for the each attribute value set, the estimated traffic of the to-be-promoted item on the each promotion platform according to the historical traffic corresponding to the plurality of historical search words on the each promotion platform comprises:
for the each attribute value set, determining an estimated impression ranking of the to-be-promoted item on the each promotion platform with each historical search word of the plurality of historical search words as a search condition, according to the values of the plurality of specified attributes in the each attribute value set and a current value of at least one additional attribute, wherein the estimated impression ranking is one of a plurality of historical impression rankings of the to-be-promoted item on the each promotion platform with the each historical search word as the search condition;
determining a traffic total probability of the to-be-promoted item on the each promotion platform according to the historical traffic corresponding to the plurality of historical search words, historical traffic corresponding to the plurality of historical impression rankings, and the estimated impression ranking corresponding to the each historical search word on the each promotion platform, wherein the traffic total probability characterizes a traffic ratio of the to-be-promoted item on the each promotion platform;
for the each promotion platform, determining a traffic marginal probability of the each promotion platform according to historical total traffic corresponding to the plurality of historical search words on the each promotion platform and historical total traffic corresponding to all of the plurality of historical search words on all of the plurality of promotion platforms; and
for the each attribute value set, determining the estimated traffic of the each promotion platform according to the traffic marginal probability and the traffic total probability corresponding to the each promotion platform and the historical total traffic corresponding to the plurality of historical search words.

18. The item information push apparatus according to claim 17, wherein the determining a traffic total probability of the to-be-promoted item on the each promotion platform comprises:
for the each historical search word, determining a traffic marginal probability of the each historical search word on the each promotion platform according to the historical total traffic corresponding to the each historical search word on the each promotion platform and the historical total traffic corresponding to all of the plurality of historical search words on all of the plurality of promotion platforms;
for the each historical search word, determining a traffic conditional probability of each historical impression ranking of the plurality of historical impression rankings of the to-be-promoted item on the each promotion platform with the each historical search word as the condition, according to the historical traffic of the to-be-promoted item corresponding to the each historical impression ranking on the each promotion platform and the historical total traffic of the to-be-promoted item corresponding to the each historical search word on the each promotion platform;
for the each historical search word, determining a traffic conditional probability corresponding to the estimated impression ranking from the traffic conditional probabilities of the plurality of historical impression rankings; and
for the each promotion platform, determining the traffic total probability of the to-be-promoted item on the each promotion platform according to traffic marginal probabilities of the plurality of historical search words corresponding to the each promotion platform on the each promotion platform and the traffic conditional probability corresponding to the estimated impression ranking.

19. The non-transitory computer readable storage medium according to claim 14, wherein the determining an estimated warehouse-out quantity of the to-be-promoted item on a plurality of promotion platforms comprises:
for the each attribute value set, determining a promotion traffic value of each promotion platform of the plurality of promotion platforms for the to-be-promoted item according to the historical traffic and the historical warehouse-out quantities corresponding to the plurality of reference items on the each promotion platform, wherein the promotion traffic value characterizes, for the to-be-promoted item, an warehouse-out quantity generated by per unit traffic of the each promotion platform;
for the each attribute value set, determining estimated traffic of the to-be-promoted item on the each promotion platform according to the historical traffic corresponding to the to-be-promoted item on the each promotion platform; and
for the each attribute value set, determining the estimated warehouse-out quantity of the to-be-promoted item on the plurality of promotion platforms according to the promotion traffic values and the estimated traffic of the to-be-promoted item on the plurality of promotion platforms.

20. The non-transitory computer readable storage medium according to claim 19, wherein the determining estimated traffic of the to-be-promoted item on the each promotion platform comprises:
determining a plurality of historical search words corresponding to the to-be-promoted item on the each promotion platform; and
determining, for the each attribute value set, the estimated traffic of the to-be-promoted item on the each promotion platform according to the historical traffic corresponding to the plurality of historical search words on the each promotion platform.

21. The non-transitory computer readable storage medium according to claim 20, wherein the determining, for the each attribute value set, the estimated traffic of the to-be-promoted item on the each promotion platform according to the historical traffic corresponding to the plurality of historical search words on the each promotion platform comprises:
for the each attribute value set, determining an estimated impression ranking of the to-be-promoted item on the each promotion platform with each historical search word of the plurality of historical search words as a search condition, according to the values of the plurality of specified attributes in the each attribute value set and a current value of at least one additional attribute, wherein the estimated impression ranking is one of a plurality of historical impression rankings of the to-be-promoted item on the each promotion platform with the each historical search word as the search condition;
determining a traffic total probability of the to-be-promoted item on the each promotion platform according to the historical traffic corresponding to the plurality of historical search words, historical traffic corresponding to the plurality of historical impression rankings, and the estimated impression ranking corresponding to the each historical search word on the each promotion platform, wherein the traffic total probability characterizes a traffic ratio of the to-be-promoted item on the each promotion platform;
for the each promotion platform, determining a traffic marginal probability of the each promotion platform according to historical total traffic corresponding to the plurality of historical search words on the each promotion platform and historical total traffic corresponding to all of the plurality of historical search words on all of the plurality of promotion platforms; and
for the each attribute value set, determining the estimated traffic of the each promotion platform according to the traffic marginal probability and the traffic total probability corresponding to the each promotion platform and the historical total traffic corresponding to the plurality of historical search words.
